(19) United States
(12) Patent Application Publication
(10) Pub. No.: US 2003/0093804 A1
(43) Pub. Date: May 15, 2003

(54) Seamless integration of multiple data/internet connections

(76) Inventors: Matthew S. Chang, San Diego, CA (US); Mark Kenneth Eyer, Woodinville, WA (US); Andrew M. Proehl, San Francisco, CA (US); David K.L. Yang, San Jose, CA (US); Frederick J. Zustak, Poway, CA (US); Peter Rae Shintani, San Diego, CA (US); Nicholas Colsey, Del Mar, CA (US); Brant L. Candelore, Escondido, CA (US); Dayan Ivy Golden, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/053,229

(22) Filed: Nov. 13, 2001

(51) Int. Cl. H04N 5/445; H04N 7/173

(52) U.S. Cl. 725/95; 725/39; 725/37; 725/110; 725/133

(57) ABSTRACT

An apparatus and method to increase effective data connection bandwidth by splitting/allocating data streams seamlessly and simultaneously across multiple connections. The apparatus providing for multi-tasking and switching of data between a plurality of bi-directional and/or download-only bandwidth channels for use by a plurality of end-user devices. The apparatus having decision-making means for allocating the various bandwidth channels to the appropriate data transfer tasks thereby maximizing the use of all available channels. This improves over the current prevailing scenario whereby each device has a single dedicated connection. One example of the invention is a set-top box that accepts data from satellite, modem, cable, DSL, ISDN, internet, or other inputs and routes the data to various computers, televisions, telephones, and/or stereo devices

### BACKGROUND OF THE INVENTION

The present invention relates generally to an apparatus and method for increasing effective data connection bandwidth by splitting/allocating data streams seamlessly and simultaneously across multiple connections.

### SUMMARY OF THE INVENTION

With the proliferation of data intensive electronic devices for use in the home, a need has arisen to efficiently combine and/or interconnect these devices. Many households now have more than one cable-connected television, multiple phone lines, and at least one computer; as well as VCRs, DVDs, digital recorders, game consoles, digital stereo systems, etc . . . .

The recent development of set-top boxes (STBs) is seen by many as a first step in the attempt to combine some of these devices. Set-top boxes essentially combine many of the features that are commonly found in separate end-user devices—e.g. cable boxes, VCRs, game consoles, and computers—into a single device connected to the television. Hence, the multiple boxes, connections, user interfaces, and remote controls for these separate devices are effectively consolidated.

This recent increase in the number of end-user devices has resulted in a corresponding increase in the number and types of data connections to the home. Many devices require a specific type of connection. Until recently, most homes had only phone lines and cable television lines to handle data transfers with the outside world. Now, many households are adding additional phone lines, satellite connections, DSL, ISDN, etc . . . . Generally, each of these external data channels has some associated usage based cost. In addition, many of these end-user devices use only a small fraction of the available bandwidth of their connections. As a result, a need has arisen to make more efficient use of the data connections into the home. For example, a computer user may be unable to download data using the computer's modem connection because the connection is temporarily busy or inoperable. Meanwhile, in the same room there is a bi-directional cable feed connected to the television that could download both the data and the television programming if only it was connected to the computer as well.

Therefore, a need exists for a means to efficiently interconnect the numerous data connection going into a house with the various end-user devices that need the data. This can be accomplished by having several devices share a data connection or by connecting devices to types of connections through some sort of conversion box.

The present invention provides an apparatus for splitting and allocating data streams for efficient use of the available bandwidth. The apparatus has external-side data ports for transferring data between the apparatus and a plurality of external bandwidth channels. The apparatus also has user data ports for bi-directional data transfer between the apparatus and at least one end-user device. The end-user device sends a data request for data to be transferred from an external source. A determining means is provided for determining the most efficient means for executing the data request on the basis of the external source and the available bandwidth for each of the external bandwidth channels currently connected to the external-side data ports. A switch then connects the requesting end-user device to the external bandwidth channel or channels determined by the determining means such that the data request is sent to the external source and the data is transferred accordingly. The external-side data ports of the apparatus include connections for download only and bi-directional external bandwidth channels.

The invention also provides a method for efficient data transfer through a set-top box between a plurality of external sources and at least one end-user device. The method commences when an end-user device sends a data request to the set-top box for data to be transferred from one of the external sources. The method then determines the most efficient means for executing the data request on the basis of the external source and the available bandwidth for each of a plurality of external bandwidth channels currently connected to the set-top box. Next, the method allocates the external bandwidth channels according to the determined means for executing the data request and connects the end-user device to the allocated external bandwidth channels. The data request is then sent to the external source in accordance with the allocated external bandwidth channels and data is transferred from the external source to the end-user device in response to the data request. The set-top box has a plurality of connections for download only and bi-directional external bandwidth channels.

### BRIEF DESCRIPTION OF THE DRAWINGS

For a more complete understanding of the invention, reference is made to the following description and accompanying drawings, in which:

FIG. 1 is a system block diagram of a system using a set-top box;

FIG. 2 is a functional block diagram of a digital set-top box suitable for use with the present invention;

FIG. 3 is an illustration of exemplary system connections for a digital set-top box according to the present invention; and

FIG. 4 is a flowchart showing the multi-tasking switching method according to the present invention.

### DETAILED DESCRIPTION OF PREFERRED EMBODIMENTS

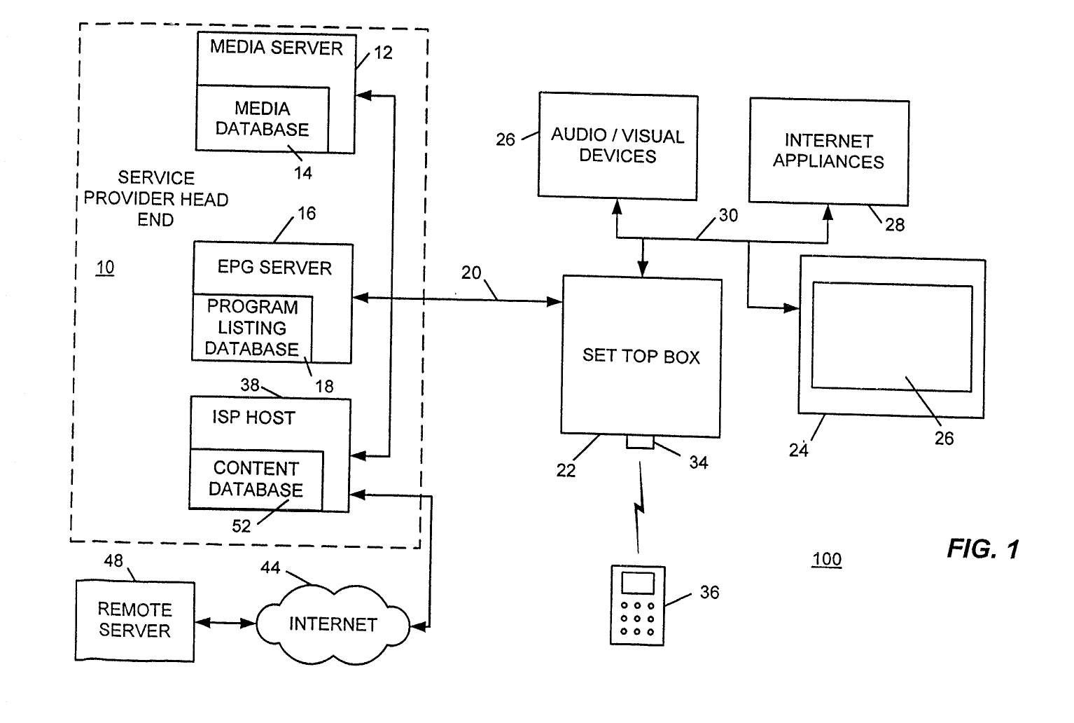

The preferred embodiments of the apparatus and method according to the present invention will be described with reference to the accompanying drawings. Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bi-directional communication over a transmission medium 20 in the case of a cable STB 22. In other embodiments, bi-directional communication can be effected using asymmetrical communication techniques possibly using dual communication media—one for the uplink and one for the downlink. In any event, the STB 22 can have its own Universal Resource Locator (URL) assigned thereto to provide for addressability by the head end and users of the Internet.

The media server 12 and EPG server 16 are coupled by transmission medium 20 to a set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc . . . . The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc . . . . Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc . . . . In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e g. using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

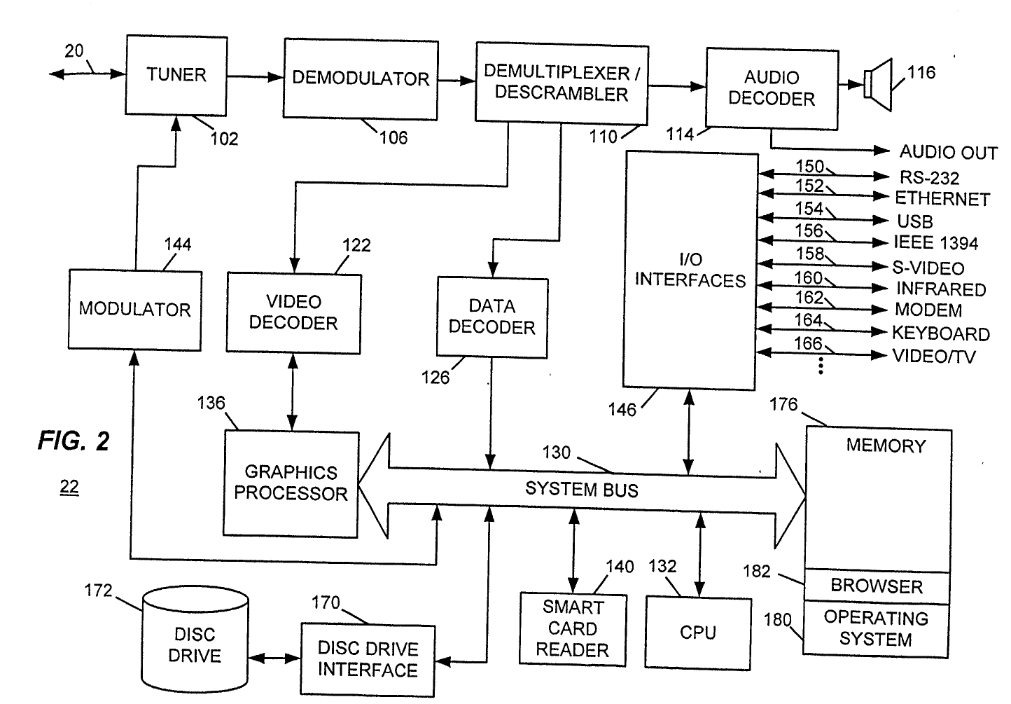

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band (0013) tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bi-directional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc. . . .

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also, include floppy disc drives, CD ROM drives, CD R/W drives, DVD drives, etc . . . . CPU 132, in order to operate as a computer, is coupled through the system bus 130 to memory 176. Memory 178 may include a combination any suitable memory technology including Random Access Memory (RAM), Read Only Memory (ROM), Flash memory, Electrically Erasable Programmable Read Only Memory (EEPROM), etc . . . .

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all include at the lowest layer various hardware interface layers. Next is an operating system layer as previously described. The software architectures of modem STBs have generally evolved to include a next layer referred to as “middleware”. Such middleware permits applications to run on multiple platforms with little regard for the actual operating system in place. Middleware standards are still evolving at this writing, but are commonly based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

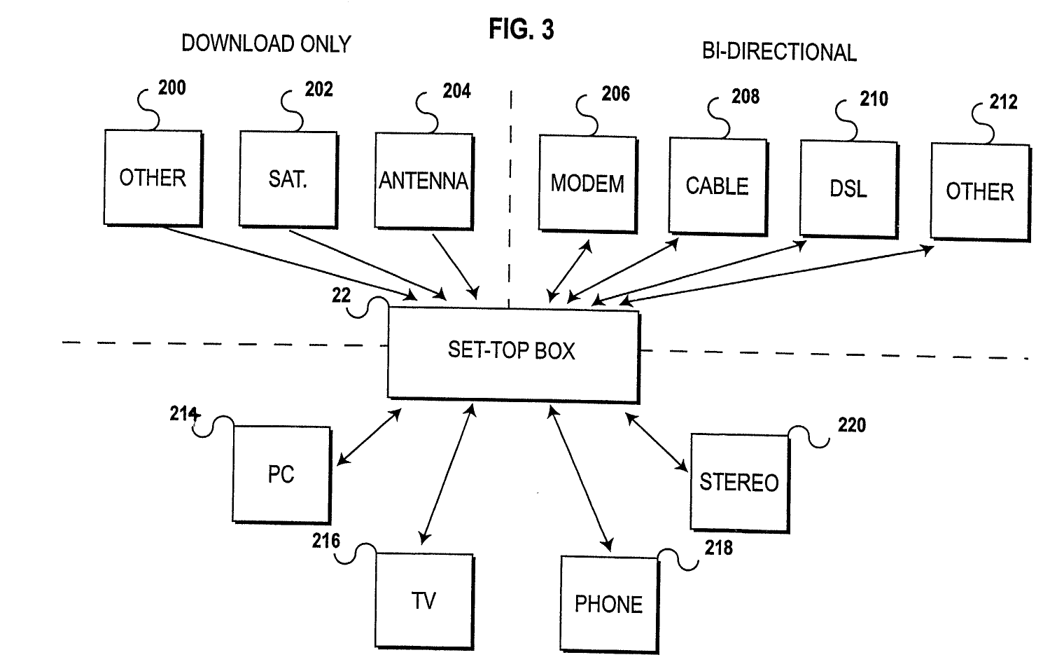

FIG. 3 is an illustration of exemplary system connections for a digital set-top box according to the present invention. Example input/output interfaces for connecting to the STB are shown in FIG. 2. (Elements 150-166) As shown in FIG. 3, STB 22 can connect and communicate with external devices using a number of communication media. The connections can be download-only or bi-directional between the STB and the external sources. Download-only communication indicates that data can only be transferred from the external source to the STB. Examples of download-only communication are satellite 202 and broadcast television 204. Bi-directional communication indicates that data can be transferred both to and from the STB and an external source. Examples of bi-directional communication are modems 206, bi-directional cable connections 208, ISDN, DSL 210, and the Internet. In some situations data can be requested by the STB from a download-only communication by directing the request to the external source through a bi-directional connection. For example, pay-per-view television programs are frequently requested using a phone modem.

In addition, STB 22 can interface with a number of end-user devices. Again, these connections can be download-only or bi-directional depending upon the device. Example end-user devices are personal computers 214, televisions 216, telephones 218, stereos 220, remote controls, monitors, communication devices, smart household appliances, etc . . . . Multiple devices can simultaneously request information through the STB.

The present invention is an apparatus and method to efficiently connect end-user devices with external data sources using a number of external bandwidth channels. The present invention provides a means for multi-tasking and switching data between a plurality of bi-directional and/or download-only bandwidth channels for use by a plurality of end-user devices. Further, the present invention has a decision-making means for allocating the various bandwidth channels to the appropriate data transfer tasks. For example, an end-user device connected to an STB requests data from an external source. The STB then determines the most efficient means for servicing the request on the basis of the various external bandwidth channels currently connected to the STB. The STB then selects the appropriate channel or channels and routes the data from the external source or sources to the end-user device or devices. Thus, the present invention increases the effective data connection bandwidth by splitting/allocating data streams seamlessly and simultaneously across multiple connections. The selection of channels and allocation of data streams is performed in accordance with predetermined internet and network architecture standards and protocols.

One embodiment of the present invention is an apparatus for splitting and allocating data streams. The apparatus has a number of external-side data ports for transferring data between a plurality of external bandwidth channels and the apparatus. The external-side data ports include connections for download-only and bi-directional external bandwidth channels. In addition, the apparatus has one or more user data ports for bi-directional data transfer between the apparatus and at least one end-user device. The end-user device can send a data request for data to be transferred from an external source. The apparatus has a determining means for determining the means for executing a data request on the basis of the external source and the available bandwidth for each of the external bandwidth channels currently connected to the external-side data ports. The apparatus also has a switch for connecting the requesting end-user device to the external bandwidth channels determined by the determining means such that the data request is sent to the external source and the data is transferred accordingly.

The apparatus can be a set-top box similar to STB 22 shown in FIG. 2. The external-side data ports and user data ports can be implemented with input/output interfaces 146. As shown in FIG. 2, these input/output interfaces may include RS-232 150, Ethernet 152, USB 154, IEEE 1394 156, S-video 158, Infrared 160, Modem 162, Keyboard 164, and video/TV 166 connections among others. The multi-tasking and decision making operations can be performed by CPU 132. The data transfer and switching operations can be performed by use of switched connections within I/O Interface 146, system bus 130, memory 176, and are controlled by CPU 132.

The decision making process for determining which external bandwidth channels are most appropriate for use in responding to a data request can be based on a variety of criteria. In the simplest situation, channel decisions can be based on which channels connect with the desired external source and are currently available for use. Similarly, decisions can be based on which channels provide the highest data transfer rate so that the data request is responded to in the shortest amount of time. Another criteria could be cost, provided that some of the bandwidth channels may have various monetary costs associated with their use. The intent of the present invention is that data requests are responded to in an efficient manner, with efficiency being defined on the basis of whatever decision criteria is currently being used. It is possible that the most efficient manner is to route all requests through a single channel. In general, the decision making process may be implemented by a computer program residing either in the STB or at an external location. This computer program and/or the decision making criteria may be provided to the STB by an outside source. The above description is intended only to provide examples for the decision making process and should not be interpreted as limiting the present invention to only these examples.

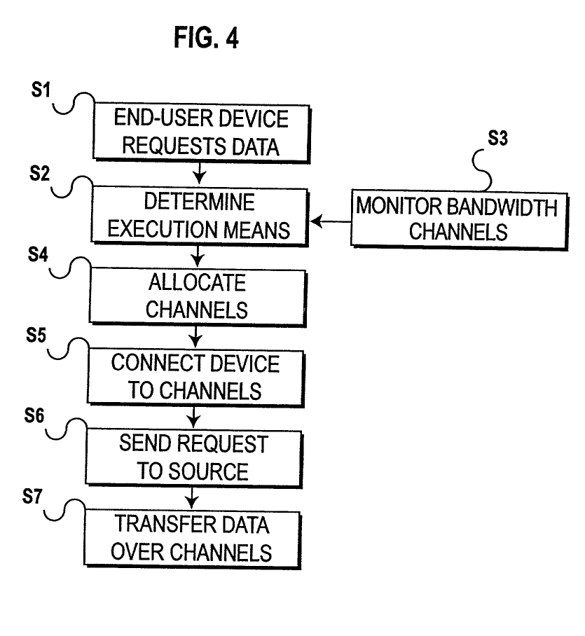

FIG. 4 is a flowchart showing one possible embodiment of the method for efficient data transfer through a set-top box between a plurality of external sources and at least one end-user device according to the present invention. In step S1 an end-user device requests data from an external source. The data request is received by the present invention which determines the means for executing the request S2 by monitoring the availability of the currently connected external bandwidth channels S3. Next, the external bandwidth channels are allocated for use in performing the request S4. The end-user device is then connected to the allocated bandwidth channels S5. Then, the request is sent over the allocated bandwidth channels to the external source S6. Finally, the data is transferred back over the allocated bandwidth channels to the requesting end-user device S7.

For this method the set-top box may have a plurality of connections for download-only and bi-directional external bandwidth channels. Further, the external bandwidth channels may include internet, telephone, and cable channels. The end-user device may be a telephone, television, computer, communication device, or other device.

The following example illustrates the operation of the present invention. Assume the apparatus is a set-top box being used by a household. One afternoon, a first member of the household is using a remote control to flip through cable stations on the television and program the VCR. Both of these devices connect through a STB. Simultaneously, the second, third, and fourth members of the household are using the telephone which also connects through the STB, conducting research over the internet for a homework assignment on a computer connected through the STB, and listening to music that is being streamed to the stereo through the STB, respectively. In this scenario, the end-user devices comprise a cable television with a remote control, a VCR, a telephone, a computer, and a stereo. To supply the data for all of these devices, the STB is likely connected to a number of external bandwidth channels. It is also likely that several of these external bandwidth channels connect to more than one of the external sources that are feeding data to the devices. Say, the third member requests a video download from an internet website. The request is received by the connected STB, which determines the most efficient means for satisfying the request. First, the STB determines which external bandwidth channels are currently connected that can satisfy the request. Next, the STB determines the available bandwidth for each channel, given that the other end-user devices may be using some of the bandwidth of the channels. The STB then decides the most efficient means, based on some predetermined efficiency criteria, for transferring the data. Next, the STB sends the request and routes the transferred data back to the end-user device according to the determined means. In this situation, assume the STB is connected to both a bi-directional cable line and a telephone modem that can access the website. Further, the STB determines the telephone modem cannot be used since the second member is currently using the phone. In addition, some of the bi-directional cable line's bandwidth is being used to stream audio to the stereo. The STB will multi-task the request with the ongoing streaming audio and route the third member's request through the bi-directional cable line.

While the preferred embodiments of the present invention have been described using specific terms, such description is for illustrative purposes only, and it is to be understood that changes and variations may be made without departing from the spirit or scope of the appended claims.

What is claimed is:

1. An apparatus for allocating data streams for use by a plurality of consumer electronic devices, comprising:
external-side data ports for transferring data between a plurality of external bandwidth channels and said apparatus;
one or more user data ports for bi-directional data transfer between said apparatus and at least one end-user device; said end-user device sending a data request for data to be transferred from an external source;
determining means for determining the means for executing said data request on the basis of the external source and the available bandwidth for each of the external bandwidth channels currently connected to said external-side data ports; and
a switch for connecting the requesting end-user device to the external bandwidth channels determined by said determining means such that said data request is sent to said external source and the data is transferred accordingly.

2. The apparatus according to claim 1, wherein said external-side data ports include connections for download-only and bi-directional external bandwidth channels.

3. The apparatus according to claim 1, wherein said apparatus is a set-top box.

4. The apparatus according to claim 1, wherein said external bandwidth channels include internet, telephone, and cable channels.

5. The apparatus according to claim 1, wherein said end-user device is a telephone, television, computer, or communication device.

6. A method for efficient data transfer through a set-top box between a plurality of external sources and at least one end-user device, comprising the steps of:
sending a data request from said end-user device to said set-top box for data to be transferred from one or more of said external sources;
determining the means for executing said data request on the basis of the external source and the available bandwidth for each of a plurality of external bandwidth channels currently connected to said set-top box;
allocating said external bandwidth channels according to the determined means for executing said data request;
connecting said end-user device to the allocated external bandwidth channels;
sending said data request to the external source in accordance with the allocated external bandwidth channels; and
transferring data from the external source to said end-user device in response to said data request.

7. The method according to claim 6, wherein said set-top box has a plurality of connections for download-only and bi-directional external bandwidth channels.

8. The method according to claim 6, wherein said external bandwidth channels include internet, telephone, and cable channels.

9. The method according to claim 6, wherein said end-user device is a telephone, television, computer, or communication device.
